(19) United States
(12) Patent Application Publication
(10) Pub. No.: US 2012/0180467 A1
(43) Pub. Date: Jul. 19, 2012

(54) ADVANCING ASSEMBLY AND POWERED SHIELD SUPPORT HEREWITH

(75) Inventors: Friedrich Wilhelm Dannehl, Hagen (DE); Holger Behnert, Wuppertal (DE); Werner Reinelt, Bochum (DE)

(73) Assignee: BUCYRUS EUROPE GMBH, Lunen (DE)

(21) Appl. No.: 13/498,706

(22) PCT Filed: Sep. 27, 2010
(86) PCT No.: PCT/IB2010/054340

§ 371 Date: Mar. 28, 2012

(30) Foreign Application Priority Data
Sep. 29, 2009 (DE) 20 2009 011 083.4

(51) Int. Cl. F15B 15/02

(52) U.S. Cl. 60/388

(57) ABSTRACT

An advancing assembly for underground powered shield support having at least one floor skid for supporting the powered shield support, an advancing beam and a substantially perpendicularly arranged lift cylinder for lifting the floor skid relative to the advancing beam during an advancing movement. The lift cylinder has a cylinder foot supported above the advancing beam and a cylinder head buttressed on a bridge and hydraulically displaceable relative to the cylinder foot. In order to improve a powered shield support and in particular the advancing assembly of a powered shield support, the lift cylinder is a double lift cylinder having a first cylinder stage, comprising the cylinder head, and a second cylinder stage, wherein a compression spring is arranged between the cylinder stages.

The invention relates to an advancing assembly for underground powered shield supports, comprising at least one floor skid for supporting the powered shield support, comprising an advancing beam for pushing a winning installation and/or for drawing up the powered shield support (advancing movement) and comprising a substantially perpendicularly arranged lift cylinder for lifting the floor skid relative to the advancing beam during an advancing movement, wherein the lift cylinder has a cylinder foot supported above the advancing beam and a cylinder head buttressed on a bridge and hydraulically displaceable relative to the cylinder foot. The invention also relates to a powered shield support comprising a shield canopy, a guide bar mechanism, hydraulic legs, a gob shield and a corresponding advancing assembly.

### BACKGROUND OF THE INVENTION

Powered shield support assemblies are used in underground mining in order to keep open the “longwall”, in which the winning apparatuses which mine the material at a working face are arranged, during the continuous operation. In order to independently push forward a winning installation, the individual powered shield support assemblies are equipped with an advancing assembly which comprises an advancing beam, usually provided with a double-acting hydraulic pushing cylinder, in order to optionally push forward the winning installation when the powered shield support is set, i.e. is fastened between footwall and roof, or draw up a released powered shield support, i.e. while the powered shield support is not fastened between roof and footwall. In underground mining, this operation is as a rule designated as an advancing movement of a powered shield support and is effected by means of the advancing assembly with which a powered shield support is provided. For advancing assemblies of the type in question, it has been known for a long time to use a floor-skid lift cylinder (base lift cylinder) with which the floor skid can be lifted during the advancing movement. This is necessary, for example, if the floor skid has dug into soft ground (footwall) and the floor skid has to be prevented from digging deeper into the ground during an advancing movement. The lifting is effected by virtue of the fact that the base lift cylinder rests with its cylinder foot on the advancing beam and lifts the floor skid relative to the advancing beam, which remains resting on the floor or footwall (cf. DE 196 33 847 C1 or DE 203 07 907 U1).

### SUMMARY OF THE INVENTION

An object of the invention is to improve a powered shield support and in particular the advancing assembly of a powered shield support.

According to the invention, it is proposed for this purpose that the lift cylinder consist of a double lift cylinder having a first cylinder stage, comprising the cylinder head, and a second cylinder stage, wherein a compression spring is arranged between the cylinder stages. The requisite construction space for the withdrawal cylinder can be considerably reduced, at the same stroke length, by the use, according to the invention, of a double lift cylinder as floor-skid lift cylinder or base lift cylinder, as a result of which powered support assemblies for small thicknesses can be provided, with which powered support assemblies the same maximum setting loads can be achieved. The compression spring at the same time ensures reliable positioning and fastening of the two cylinder stages, even if the pressure cylinder is depressurized, since the spring force of the compression spring preloads the first cylinder stage in the extension direction and to this extent keeps it fastened between the upper and lower abutment points on the powered shield support. At the same time, the compression spring additionally dampens the external forces acting on the double lift cylinder.

In an especially preferred configuration, the compression spring is supported radially over its entire length. The radial support over the entire length of the compression spring can be achieved in particular owing to the fact that, according to an especially advantageous configuration, the cylinder head is formed on a piston rod which is formed with a cavity for accommodating a spring end of the compression spring in a radially supported manner to the outside, and/or owing to the fact that the second cylinder stage is provided with a cylinder sleeve which is movable parallel to a cylinder axis and has a supporting tube arranged concentrically to the cylinder axis for radially supporting the compression spring on the inside. Furthermore, in order to achieve a minimum fitting height, it is expedient if the supporting tube has an axial length which is approximately the same as or slightly less than the axial depth of the cavity. To this end, the outside diameter of the supporting tube and the inside diameter of the cavity are adapted with clearance to the radial dimensions of the compression spring.

In the especially preferred configuration, the cylinder sleeve of the second cylinder stage is arranged in an axially displaceable manner in a cylinder housing, the base of which forms the cylinder foot. According to an advantageous configuration, the cylinder foot bears against a holding pot which is fastened to a transverse spar which is guided with play on longitudinal guides which are formed on the inner sides, facing one another, of the floor skid, e.g. on a frame structure. The transverse spar can have end pins which engage as guide pieces in the longitudinal guides. The holding pot can also be fastened with play to the transverse spar by being fastened by means of screw bolts having a free shank length. The holding pot preferably has a base plate, the underside of which runs at an angle to the cylinder axis, in order to obtain optimum support even when the cylinder axis of the lift cylinder does not run perpendicularly to the floor or the underside of the floor skid, but rather runs at a small angle of inclination of about 1° to 5°.

In order to simplify the activation of the double lift cylinder, the double lift cylinder can preferably be activated solely via connections which are arranged on the cylinder head or which are arranged on a valve housing fastened to the cylinder head. As a result, all the hydraulic hoses can be connected to the cylinder head. The piston space and annular space of the double lift cylinder are then hydraulically supplied solely via the cylinder head, via the cavity of the piston rod and by passages in the piston rod wall. Furthermore, at least one non-return valve and/or a pressure relief valve can be arranged in the cylinder head.

These and other objects, aspects, features, developments and advantages of the invention of this application will become apparent to those skilled in the art upon a reading of the Detailed Description of Embodiments set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 shows a powered shield support with advancing assembly according to the invention in side view, partly truncated;

FIG. 2 shows the double lift cylinder used according to the invention in the advancing assembly on the powered shield support according to FIG. 1, in a front view of the powered shield support, partly truncated;

FIG. 3 shows a detailed view of the double lift cylinder on the powered shield support in side view, partly truncated;

FIG. 4 shows the double lift cylinder in side view;

FIG. 5A shows the double lift cylinder in vertical section in the completely retracted lifting position;

FIG. 5B shows the double lift cylinder with extended first cylinder stage; and

FIG. 5C shows the double lift cylinder with extended first cylinder stage and extended second cylinder stage.

### DETAILED DESCRIPTION OF EMBODIMENTS

Referring now to the drawings wherein the showings are for the purpose of illustrating preferred and alternative embodiments of the invention only and not for the purpose of limiting same, shown overall by reference numeral 1 in FIG. 1 is a powered shield support which can be used in underground mining for keeping open a longwall in continuous winning operation. In a manner known per se, the powered shield support 1 has a shield canopy 2, a gob shield 3, a guide bar mechanism 6 formed by means of guide bars 4, 5 provided in pairs, a floor skid 7, and at least two hydraulic legs 8, with which the shield canopy 2, on account of its articulated connection to the floor skid 7 via guide bar mechanism 6 and gob shield 3, can move substantially parallel to the floor skid 7. In normal operation, the floor skid 7 rests with the underside thereof on the intimated floor rock, i.e. on the “footwall”. In order to be able to push forward a winning installation (not shown) when powered shield support 1 is set, i.e. fastened between formation (roof) and floor (footwall), or in order to be able to draw up a powered shield support in an advancing movement when the powered shield support is released, an advancing beam 9 is arranged in a space between the floor skids 7, the advancing beam 9 being provided with an advancing-beam head 9A which is attached to side cheeks of a conveyor installation, as is known per se to a person skilled in the art for underground mining. The advancing beam 9 is supported on a transverse bridge at the rear end of the floor skid 7, and the two floor skids 7 can form a virtually rigid substructure for the powered shield support 1.

FIG. 1 shows the powered shield support 1 during an advancing movement. The footwall or floor skid 7 rests on the footwall close to the rear end thereof, whereas the front end of the floor skid 7 is lifted by means of the lift cylinder (designated overall by reference numeral 10), which in this case consists of a two-stage double lift cylinder. It can be seen relatively clearly from FIG. 1 that the double lift cylinder 10 has an upper first cylinder stage 11 and a lower second cylinder stage 12, the construction of which will be described further below.

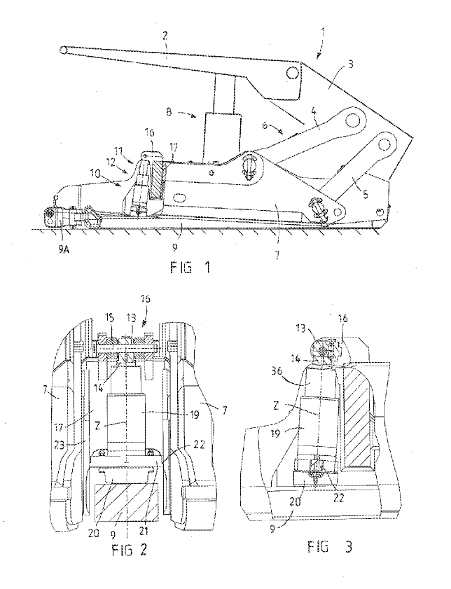

FIGS. 2 and 3 show a detailed view of the double lift cylinder 10 arranged in the space between the floor skids 7. The double lift cylinder 10 has a cylinder head 13, which is designed here as an integral component on a piston rod 14 substantially forming the first cylinder stage. The cylinder head 13 is supported by means of a sturdy transverse pin 15 on a bridge 16 which is formed on the top end of a transverse wall 17 rigidly connecting the floor skids 7 to one another. The second cylinder stage 12 consists substantially of a cylinder sleeve 36 which is displaceably guided parallel to the cylinder axis Z in a cylinder housing 19. The base of the cylinder housing 19 forms a cylinder foot which, in FIGS. 1 to 3, is supported on the top side of the advancing beam 9, or rests in place there, via a holding pot 20. The holding pot 20 is in turn screwed to a transverse spar 21 which is guided by means of schematically indicated end guide s lots 22 in slot- or channel-like vertical guides (not shown) of a frame 23 which is fastened on the inside to each floor skid 7. The transverse spar 21 therefore positions the holding pot 20 transversely to the cylinder axis Z, whereas the guide slots in the frame 23 run perpendicularly and in a plane-parallel manner to the cylinder axis Z in order to be able to lift the floor skids 7 relative to the advancing beam 9 via the double lift cylinder 10.

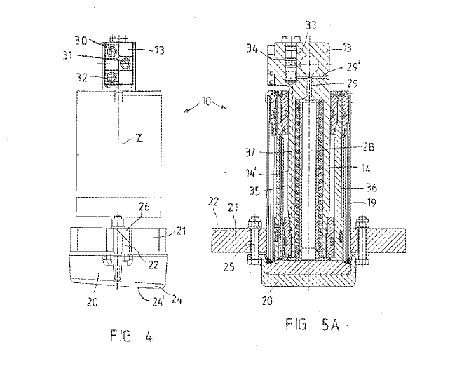

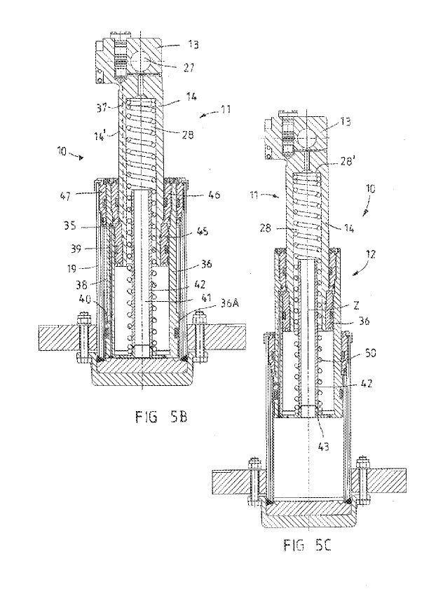

Reference will now be made to FIG. 4 and FIGS. 5A, 5B, 5C, in which the double lift cylinder 10, together with transverse spar 21 and holding pot 20, used according to the invention in the advancing assembly is shown in detail. It can readily be seen in particular from FIG. 4 that the holding pot 20 has a base plate 24, the underside 24′ of which runs at an angle of, here, 93° to the cylinder axis Z. The slope of 3° relative to the plane normal to the cylinder axis Z substantially corresponds to the deviation of the cylinder axis Z in the assembled state from an orientation perpendicular to the top side of the advancing beam 9. The holding pot 20 is screwed to the transverse spar 21, here by means of two screw bolts 25, which if need be allow certain play between holding pot 20 and transverse spar 21. The guide extensions 22 are each provided with a wedge-shaped notch 26.

The double lift cylinder 10 is shown in different extension positions in FIGS. 5A, 5B and 5C. The first cylinder stage 11 consists substantially of the piston rod 14, the top end of which integrally forms the cylinder head 13 having a transverse bore 27 for the fastening pin (15, FIG. 2) and which is provided with a bore as cavity 28 up close to the cylinder head 13. In the region in which the cavity 28 extends, the piston rod 14 therefore consists only of a cylindrical rod wall 14′. The entire hydraulic loading of the pressure cylinder 10 is effected via the cylinder head 13. A hydraulic connection 30 for the annular areas of the cylinder stages 11, 12 and a second hydraulic connection 31 for the piston areas of the cylinder stages and also a third hydraulic connection 32 are formed on the cylinder head 13 for this purpose. Transversely to the connections 30, 31, 32, a locating bore 33 for a non-return valve 34 is formed in the cylinder head 13. A pressure relief valve (not shown) can preferably be fitted at the connection 32. The pressure is applied to the piston sides of the two cylinder stages 11, 12 via a transverse bore 29′ and an axial bore 29 leading into the cavity 28 of the piston rod 14. The pressure is applied or hydraulic fluid flows off from the annular spaces, such as, for example, the annular space 35 between the first cylinder stage 11 formed by the piston rod 14 and the second cylinder stage 12 formed by the cylinder sleeve 36 guided in the cylinder housing 19, via an axial passage 37, indicated in FIG. 5A by the broken line, in the piston rod wall 14′ and via radial passages which connect the axial passage 37 to the annular space 35. The annular space 38 between the cylinder housing 19 and the cylinder sleeve 36 is subjected to flow via the annular space 35 remaining in the extended state of the first cylinder stage, a transverse bore, a further axial passage 39 and a radial bore 40. The hydraulic loading of the piston side of the cylinder sleeve 36 forming the second cylinder stage 12 is effected via the cavity 28 and via an inner passage 41 in a supporting tube 42 which extends upwards from the base 43 of the cylinder sleeve 36 in an axially parallel manner and concentrically to the cylinder axis Z. The outside diameter of the supporting tube 42 is markedly smaller than the inside diameter of the cavity 28 of the piston rod 14, and a compression spring 50 is arranged between the base 43 of the cylinder sleeve 36 and the end wall 28′ of the cavity 28. The compression spring 50 bears with its lower spring end against the base 43 of the cylinder sleeve 36 and with its upper end against the end wall 28′. The coiling of the compression spring 50 is selected in such a way that the compression spring 50 is supported at least on one side over its entire length, irrespective of the extension state of the pressure cylinder 10. To this end, the compression spring 50 bears against the outer wall of the supporting tube 42 and against the inner side of the piston rod wall 14′ of the piston rod 14. The respective radial support of the compression spring 50 over its entire axial length via the supporting tube 42 on the one hand and via the piston rod wall 14′ of the piston rod 14 on the other hand ensures that the compression spring 50, irrespective of the extension state of the double lift cylinder 10, cannot buckle even under high forces.

The piston rod 14 is guided inside the cylinder sleeve 36 via a guide collar 45 at the lower end of the piston rod 14 and via a guide collar 46 on the inner circumference of the cylinder sleeve 36. The two guide collars 45, 46 are also provided with locating grooves for sealing rings or sealing collars. The guide collars 45, 46 at the same time ensure that the individual annular spaces 35, 38 can be subjected to flow via the axial passages 37 and 39, respectively. The guide collars 45, 46 are in each case detachably fastened to the piston rod 14 and the cylinder sleeve 36, respectively. The cylinder sleeve 36 is guided inside the cylinder housing 19 via a lower, wider guide section 36A, which is integrally formed on the cylinder sleeve 36 and on which further locating grooves for seals are formed, and via a third, detachable guide collar 47 which is fastened, in particular fixedly screwed, to the inner circumference of the cylinder housing 19. The guide collar 47, too, has locating grooves for sliding seals on its inner side. Since the mechanical construction of a double lift cylinder with guide collars is known from the prior art, further description is not given here.

An overflow valve or pressure relief valve, for example, can be arranged in the third connection 32 of the cylinder head 13 in order to allow hydraulic fluid to flow off from the piston space between the first and the second cylinder stages and the cylinder housing or else from the respective annular spaces in the event of an overload. The arrangement of all the piston connections 30, 31 and 32 in the cylinder head simplifies the running of hoses.

For the person skilled in the art, numerous modifications which are to come within the scope of protection of the attached claims emerge from the above description. Depending on the requisite stroke length and the requisite lifting pressure, the piston spaces and the annular spaces can have different area relationships.

Further, while considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-12. (canceled)

13. An advancing assembly for an underground powered shield support, comprising at least one floor skid for supporting the powered shield support, comprising an advancing beam for an advancing movement of the powered shield support and comprising a substantially perpendicularly arranged lift cylinder for lifting the floor skid relative to the advancing beam during an advancing movement, wherein the lift cylinder has a cylinder foot supported above the advancing beam and a cylinder head buttressed on a bridge and hydraulically displaceable relative to the cylinder foot, the lift cylinder includes a double lift cylinder having a first cylinder stage having the cylinder head, and a second cylinder stage, wherein a compression spring is arranged between the first and second cylinder stages.

14. The advancing assembly according to claim 13, wherein the compression spring is supported radially over its entire length.

15. The advancing assembly according to claim 13, wherein the cylinder head is formed on a piston rod which is formed with a cavity for accommodating a spring end of the compression spring in a radially supported manner.

16. The advancing assembly according to claim 13, wherein the second cylinder stage is formed by a cylinder sleeve which is movable parallel to a cylinder axis and has a supporting tube arranged concentrically to the cylinder axis for radially supporting the compression spring.

17. The advancing assembly according to claim 16, wherein the cylinder head is formed on a piston rod which is formed with a cavity for accommodating a spring end of the compression spring in a radially supported manner, the supporting tube has an axial length which corresponds approximately to an axial depth of the cavity in the piston rod.

18. The advancing assembly according to claim 17, wherein an outside diameter of the supporting tube and an inside diameter of the cavity are adapted with clearance to the radial dimensions of the compression spring.

19. The advancing assembly according to claim 16, wherein the cylinder sleeve of the second cylinder stage is arranged in an axially displaceable manner in a cylinder housing, the base of which forms the cylinder foot.

20. The advancing assembly according to claim 19, wherein the cylinder foot bears against a holding pot which is fastened to a transverse spar which is guided with play on a frame or the like connected to the floor skid.

21. The advancing assembly according to claim 20, wherein the holding pot has a base plate, the underside of which runs at an angle to the cylinder axis.

22. The advancing assembly according to claim 13, wherein the double lift cylinder can be activated by way of at least one of hydraulic connections and a non-return valve which are arranged at least one of in and on the cylinder head which is arranged on a valve housing fastened to the cylinder head.

23. The advancing assembly according to claim 13, wherein the double lift cylinder is hydraulically supplied by way of the cylinder head, the cavity of the piston rod and an axial passage in a piston rod wall.

24. A powered shield support comprising a shield canopy, comprising at least one floor skid, comprising hydraulic legs, with which the shield canopy is movable relative to the floor skid, comprising a guide bar mechanism and comprising an advancing assembly having an advancing beam for moving the powered shield support and a substantially perpendicularly arranged lift cylinder for lifting the floor skid relative to the advancing beam during an advancing movement, wherein the lift cylinder has a cylinder foot supported above the advancing beam and a cylinder head buttressed on a bridge and hydraulically displaceable relative to the cylinder foot, the lift cylinder includes a double lift cylinder having a first cylinder stage having the cylinder head, and a second cylinder stage, wherein a compression spring is arranged between the first and second cylinder stages.

25. The powered shield support according to claim 24, wherein the compression spring is supported radially over its entire length.

26. The powered shield support according to claim 24, wherein the cylinder head is formed on a piston rod which is formed with a cavity for accommodating a spring end of the compression spring in a radially supported manner.

27. The powered shield support according to claim 24, wherein the second cylinder stage is formed by a cylinder sleeve which is movable parallel to a cylinder axis and has a supporting tube arranged concentrically to the cylinder axis for radially supporting the compression spring.

28. The powered shield support according to claim 27, wherein the cylinder head is formed on a piston rod which is formed with a cavity for accommodating a spring end of the compression spring in a radially supported manner, the supporting tube has an axial length which corresponds approximately to an axial depth of the cavity in the piston rod.

29. The powered shield support according to claim 28, wherein an outside diameter of the supporting tube and an inside diameter of the cavity are adapted with clearance to the radial dimensions of the compression spring.

30. The powered shield support according to claim 27, wherein the cylinder sleeve of the second cylinder stage is arranged in an axially displaceable manner in a cylinder housing, the base of which forms the cylinder foot.

31. The powered shield support according to claim 30, wherein the cylinder foot bears against a holding pot which is fastened to a transverse spar which is guided with play on a frame or the like connected to the floor skid.

32. The powered shield support according to claim 31, wherein the holding pot has a base plate, the underside of which runs at an angle to the cylinder axis.

33. The powered shield support according to claim 24, wherein the double lift cylinder can be activated by way of at least one of hydraulic connections and a non-return valve which are arranged at least one of in and on the cylinder head which is arranged on a valve housing fastened to the cylinder head.

34. The powered shield support according to claim 24, wherein the double lift cylinder is hydraulically supplied by way of the cylinder head, the cavity of the piston rod and an axial passage in a piston rod wall.
